(19) United States
(12) Patent Application Publication
(10) Pub. No.: US 2017/0318153 A1
(43) Pub. Date: Nov. 2, 2017

(54) COMMUNICATION METHOD AND DEVICE

(71) Applicant: Orange, Paris (FR)

(72) Inventors: Emmanuel Le Huerou, Saint Quay Perros (FR); Nathalie Begoc Becam, Lannion (FR); Eric Beaufils, Langoat (FR); Francois Toutain, Louannec (FR)

(21) Appl. No.: 15/526,714

(22) PCT Filed: Nov. 6, 2015
(86) PCT No.: PCT/FR2015/053006

§ 371 Date: May 12, 2017

(30) Foreign Application Priority Data
Nov. 13, 2014 (FR) 1460966

(51) Int. Cl. H04M 3/436; H04M 1/725

(52) U.S. Cl. CPC H04M 3/436; H04M 1/72519; H04M 2203/651

(57) ABSTRACT

A communication method between a terminal transmitting a communication request and a receiving terminal is disclosed. The method includes the receiving terminal receiving the communication request, the communication request including a proposed communication mode for the requested communication. After a user interaction carried out on the receiving terminal indicating the selection of another communication mode different from the proposed communication mode, an acceptance message is sent to the transmitting terminal, the acceptance message including the other selected communication mode. After sending the acceptance message, the display of a display device associated with the receiving terminal is modified such that a communication interface relative to said other communication mode is displayed. Communication between the receiving terminal and the transmitting terminal then occurs according to the other communication mode, via the communication interface.

When a called user receives a communication request on his or her terminal, for example an audio or video call, if the called user is available to communicate and wants to accept the communication request, the accepted communication is set up according to a communication mode proposed in the initial communication request. For example, for an audio call, the accepted communication is set up in audio mode. For a video call, the accepted communication is set up in video mode or in audio mode only if, on accepting the communication request, the called user has selected only the audio component of the video mode proposed in the communication request.

However, it may be that the called user is available to communicate but does not want to set up the communication according to the communication mode proposed (audio or video mode) in the communication request.

For example, such a case occurs because the proposed communication mode is too intrusive for the called user who prefers to communicate non-verbally. Or else, the proposed communication mode is not suited to the context of the called user. For example, if the called user receives an audio call and is attending a conference, a communication in audio mode is not appropriate.

In such cases, the called user can reject the communication request received by requesting redirection of the communication request to the messaging service associated with his or her terminal.

On rejecting the communication request, the called user can also send a response message to the calling user by selecting, for example, a discrete response button during the communication request reception phase. Such a phase corresponds to the ringing phase of the terminal indicating the reception of the communication request.

The terminal of the called user then displays a menu in which the called user can select a predefined message, for example “I am in a meeting” or “I will call you later” or else select an option to draft a new message. The message selected or drafted by the called user is then sent in the form of an SMS (short message service) to the terminal of the calling user. This mechanism makes it possible to indicate to the calling user the reason why his or her call failed. However, according to this mechanism, the communication initially requested is terminated. If the calling user wants to communicate with the called user, a new communication request must be initiated.

While the response message is being drafted, the calling user sees his or her communication request having failed but without knowing the reason why until he or she has received the response message from the called user. Furthermore, in order to know the content of the response message received by the terminal of the calling user, the calling user must interact on his or her terminal to change communication application and open the communication application allowing him or her to read the response message. Furthermore, on reception of the response message, the calling user does not necessarily know that the response message received is sent by the called user that he or she has just tried to contact.

On the calling user side, such a discrete response mechanism can cause a degree of frustration because his or her need to communicate synchronously, that is to say with exchanges in real time, is not satisfied.

On the called user side, such a discrete response mechanism can also be the source of problems, even errors, in case of selection of a wrong response mode, because the called user must select his or her response mode (acceptance in audio mode, rejection of the communication, selection of a response message from a list of messages) while his or her terminal is ringing indicating that a communication request is received.

Often, when the called user hears his or her terminal ringing, several seconds are required for him or her to access his or her terminal, then to identify the origin of the received called, then to determine the response to be made to such a call according to the context of the user (if he or she is in a meeting, in a car, in the street, at work, etc.) and possibly the origin of the call, and finally to select the determined response. All these steps must be made by the called user while his or her terminal is ringing, before the communication request is redirected to the messaging service associated with the called terminal. When the called user receives a communication request, he or she is often in a state of stress that does not allow him or her to make an optimal choice according to his or her situation and the origin of the call when too many response mode choices are presented to him or her during the ringing phase of his or her terminal. The user may then select, on his or her called terminal, an incorrect response mode, that is to say a response mode that does not correspond to the one that he or she wanted.

One of the aims of the invention is to provide improvements to the prior art.

To this end, it proposes a communication method between a terminal transmitting a communication request and a receiving terminal, comprising the following steps:
reception, by the receiving terminal, of the communication request, the communication request including a communication mode proposed for setting up the requested communication,
following the detection of a user interaction indicating the selection of another communication mode, the other communication mode being different from the proposed communication mode and not included in the proposed communication mode, sending to the transmitting terminal of an acceptance message, the acceptance message including said other selected communication mode,
following the sending of the acceptance message, modification of the display of a display device associated with the receiving terminal so that a communication interface relating to said other communication mode is displayed,
communication between the receiving terminal and the transmitting terminal according to said other communication mode, via said communication interface.

Thus, according to the invention, the user of the receiving terminal can accept the communication request by selecting another communication mode different from the communication mode proposed in the communication request. Such another communication mode is a communication mode which is not included in the proposed communication mode, that is to say that it does not correspond to a component of the proposed communication mode. For example, if the communication request proposes the video communication mode, an audio communication mode is a component of such a video communication mode which, as is known, comprises an audio component and a video component consisting of sequences of images. On the other hand, a text or drawing communication mode is not a component of a video communication mode.

The invention thus makes it possible to adapt the communication mode of the communication to be set up according to the preferences of the user of the receiving terminal while satisfying the need for synchronous communication, or real-time communication, of the user of the terminal transmitting the communication request.

Although the communication mode according to which the communication is set up is different from the communication mode initially proposed in the communication request, the user of the receiving terminal can nevertheless communicate in real time with the user of the transmitting terminal.

According to the invention, through a single user interaction to select the other communication mode, the display of the receiving terminal switches automatically to a communication interface relating to the other communication mode. The user of the receiving terminal does not need to initiate a new communication request to change the requested communication mode.

The user interaction can be made by the activation of a key or of a button on an interface of the receiving terminal. In a variant, the user interaction can be made by a voice command. The different embodiments or features mentioned hereinbelow can be added independently or in combination with one another, to the steps of the communication method defined above.

According to a particular embodiment of the invention, the proposed communication mode is an audio or video communication mode.

According to another particular embodiment of the invention, the other communication mode is a real-time text or drawing communication mode.

This particular embodiment of the invention is advantageous when the user of the receiving terminal prefers to communicate by real-time exchanges of text messages or of real-time drawings, for example via an instant messaging session.

This particular embodiment of the invention is also advantageous when the context of the user of the receiving terminal does not allow him or her to communicate verbally or he or she must not make any noise to communicate.

According to another particular embodiment of the invention, the communication method comprises a step of determination of the other communication mode, based on an indication associated with a user of the terminal transmitting the communication request, said indication being stored on the receiving terminal.

This particular embodiment of the invention makes it possible to adapt the other communication mode proposed by the receiving terminal to the user of the receiving terminal on the reception of the communication request for example according to the habitual modes of communication between the user of the transmitting terminal and the user of the receiving terminal. This particular embodiment of the invention is advantageous in that it makes it possible to limit the number of possible choices of responses to a communication request by proposing to the user of the receiving terminal only one other communication mode. For example, only three possible response modes (acceptance according to the communication mode initially proposed in the communication request, rejection of the communication request, acceptance according to the other communication mode) are proposed to the user of the receiving terminal on the reception of the communication request. Thus, the user of the receiving terminal is not swamped by a large number of possible communication modes and can quickly decide on the response to be made to the communication request received.

According to another particular embodiment of the invention, the communication method further comprises a step of obtaining a parameter representative of the time remaining before the rejection of the communication request by the receiving terminal and a step of modification of the display of the display device so as to display the parameter obtained.

This particular embodiment of the invention makes it possible to inform the user of the receiving terminal of the time remaining before the communication request is rejected. Thus, the user of the receiving terminal knows how much time he or she has available to be able to select a response mode before the communication request is rejected by the receiving terminal. Such a rejection corresponds to an automatic selection of a response mode by the receiving terminal.

According to another particular embodiment of the invention, the other communication mode is a text or drawing communication mode and, when a message is composed via the communication interface displayed by the display device associated with the receiving terminal, the composed message is sent character-by-character to the transmitting terminal.

This particular embodiment of the invention makes it possible to inform the user of the transmitting terminal that a text message is currently being composed. Thus, the user of the transmitting terminal can begin to read the message from the user of the receiving terminal from the start of the composition of the message.

The invention relates also to a method for requesting a communication between a terminal transmitting said communication request and a receiving terminal, the communication request including a communication mode proposed for setting up the requested communication, the method comprising:
a step of reception, by the transmitting terminal, of a communication request acceptance message, the acceptance message including another communication mode different from the proposed communication mode,
following the step of reception of the acceptance message, a step of modification of the display of a display device associated with the transmitting terminal so that a communication interface relating to said other communication mode is displayed,
a step of communication between the receiving terminal and the transmitting terminal according to said other communication mode, via said communication interface.

The display of the transmitting terminal switches automatically to a communication interface relating to the other communication mode. The user of the transmitting terminal does not need to initiate a new communication request or interact on his or her terminal to communicate with the user of the receiving terminal or to know the response from the user of the receiving terminal.

The invention relates also to a communication terminal comprising a device comprising:
a communication module capable:
   of receiving a communication request from a transmitting terminal, the communication request including a communication mode proposed for setting up the requested communication,
   of sending, on command from a processing module, to the transmitting terminal, an acceptance message including another communication mode different from the proposed communication mode,
   of communicating with the transmitting terminal according to said other communication mode, via a communication interface relating to said other communication mode,
the processing module being capable:
   of controlling the communication module following a user interaction performed on the communication terminal indicating the selection of said other communication mode,
   of controlling a display interface to modify the display of a display device associated with the communication terminal so that said communication interface relating to said other communication mode is displayed.

The invention relates also to a terminal requesting a communication comprising a device comprising:
a communication module capable:
   of sending to a receiving terminal a communication request including a communication mode proposed for setting up the requested communication,
   of receiving a communication request acceptance message, the acceptance message including another communication mode different from the proposed communication mode,
   of communicating with the receiving terminal according to said other communication mode, via a communication interface relating to said other communication mode,
a processing module capable of controlling a display interface following the reception of the acceptance message, to modify the display of a display device associated with the terminal so that said communication interface relating to said other communication mode is displayed.

In a particular embodiment of the invention, the different steps of the communication and communication request method are implemented by computer program instructions.

Consequently, the invention also targets computer programs on an information medium, these programs being likely to be implemented respectively in a terminal, or more generally in a computer, these programs respectively comprising instructions suitable for implementing different steps of the communication method and different steps of the communication request method which have just been described.

These programs can use any programming language, and be in the form of source code, object code, or intermediate code between source code and object code, such as in a partially-compiled form, or in any other desirable form.

The invention also targets a computer-readable information medium, comprising instructions of a computer program as mentioned above.

The information medium can be any entity or device capable of storing the program. For example, the medium can comprise a storage means, such as a ROM, for example a CD ROM or a microelectronic circuit ROM, or even a magnetic or electronic registering means, for example a USB key or a hard disk.

Also, the information medium can be a transmissible medium such as an electrical or optical signal, which can be routed via an electrical or optical cable, wirelessly or by other means. The program according to the invention can in particular be downloaded over a network of Internet type.

Alternatively, the information medium can be an integrated circuit in which the program is incorporated, this circuit being adapted to execute or to be used in the execution of the communication method or the communication request method concerned.

The advantages of the communication terminal, of the communication request terminal, of the computer program comprising instructions suitable for implementing different steps of the communication method and the computer program comprising instructions suitable for implementing different steps of the communication request method are identical to those presented in relation to the communication method and to those presented in relation to the communication request method according to any one of the particular embodiments mentioned above.

### LIST OF FIGURES

Other advantages and features of the invention will become more clearly apparent on reading the following description of a particular embodiment of the invention, given as a simple illustrative and nonlimiting example, and the attached drawings, in which:

FIG. 1 illustrates an environment for implementation of the invention according to a particular embodiment of the invention,

FIG. 2 schematically illustrates steps of the communication request method and steps of the communication method according to a particular embodiment of the invention,

FIGS. 3A, 3B and 3C schematically illustrate an interface of a terminal implementing the communication request method according to a particular embodiment of the invention,

FIGS. 4A and 4B schematically illustrate an interface of a terminal implementing the communication method according to a particular embodiment of the invention,

FIG. 5 illustrates a device capable of implementing the communication request method according to a particular embodiment of the invention,

FIG. 6 illustrates a device capable of implementing the communication method according to a particular embodiment of the invention.

### DESCRIPTION OF A PARTICULAR EMBODIMENT OF THE INVENTION

FIG. 1 illustrates an environment for implementation of the invention according to a particular embodiment of the invention. The environment described in FIG. 1 comprises a communication network RES making it possible to exchange data and set up communications between terminals connected to the communication network RES. For example, the communication network RES is a mobile IP communication network of 4G type or a fixed IP communication network. The communication network RES is, for example, an IP communication network based on an IMS (IP multimedia subsystem) architecture.

The communication network RES can also be a group of communication networks interconnected with one another by interconnection servers (not represented). The environment of FIG. 1 also comprises terminals TE and TR connected to the communication network RES.

The terminals TE and TR can be any type of terminals making it possible to set up a telephone or video phone communication, such as a cell phone, a smartphone, a tablet, a television connected to a communication network, a personal computer on which a telephony application, also called soft phone, is installed, or anything connected to a communication network.

More particularly, the terminals TE and TR are capable of communicating via the communication network RES during a communication set up in audio or video phone mode, or during a communication set up in text or drawing mode such as in an instant messaging session.

According to a particular embodiment of the invention, the terminal TE and the terminal TR are capable of setting up a communication according to the WebRTC technology. Such a WebRTC technology makes it possible to set up communications between the terminal TE and the terminal TR over an IP communication network, for example the communication network RES, via the web browser of each terminal.

According to this particular embodiment of the invention, the environment of FIG. 1 comprises an application server SERV managing the signaling of a communication to be set up between the terminals TE and TR. The application server SERV registers the terminals TE and TR when the latter signal to the application server SERV that they are available to communicate according to the WebRTC protocol. The application server SERV keeps a first communication channel open with the terminal TE and a second communication channel open with the terminal TR. Such communication channels allow the application server SERV to receive a communication request from the terminal TE or from the terminal TR to another terminal or to inform the terminal TE or the terminal TR that a communication request is intended for it. When a communication is set up between the terminals TE and TR, the communication data streams do no pass through the application server SERV, but directly point-to-point between the terminals TE and TR, via the communication network RES.

According to another particular embodiment of the invention, the terminal TE and the terminal TR are capable of setting up a communication according to the SIP (session initiation protocol) protocol.

According to this other particular embodiment of the invention, the signaling of a communication to be set up between the terminals TE and TR is managed by application servers of the IMS core of the communication network RES. In order to receive or transmit a communication, the terminal TE, respectively TR, is registered with the core of the communication network RES, by the sending of an SIP REGISTER message. The setting up of a communication between the terminal TE and the terminal TR is done by the exchange of SIP messages (INVITE, 180 Ringing, 2000K, ACK) between the terminals TE and TR, via the core of the communication network RES. When a communication is set up between the terminals TE and TR, the data streams of the communication pass directly point-to-point between the terminals TE and TR, via the communication network RES.

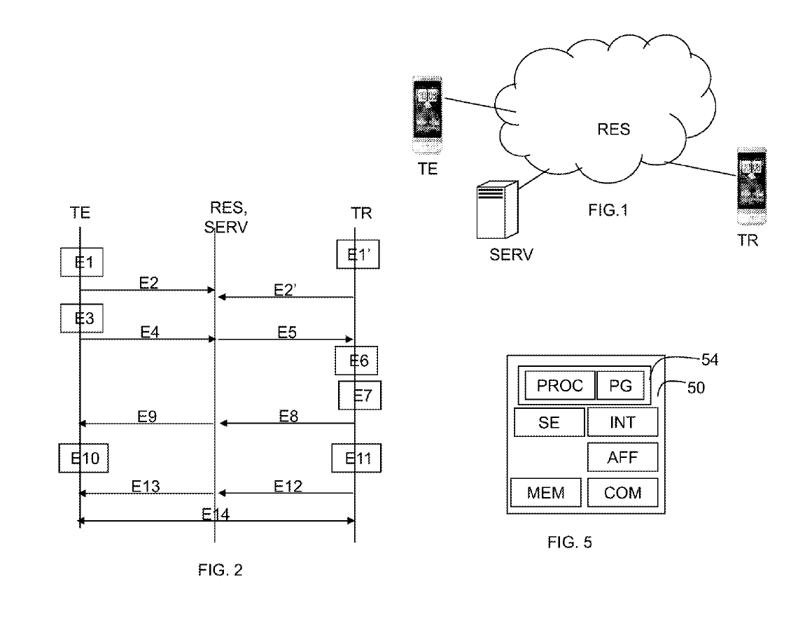

FIG. 2 schematically illustrates steps of the method for a communication request implemented the terminal TE of FIG. 1 and steps of the communication method implemented by the terminal TR of FIG. 1, according to a particular embodiment of the invention. The steps of FIG. 2 are described in relation to the WebRTC technology.

During a step E1, the user of the terminal TE starts up the communication service of his or her terminal by starting up an execution of the web browser installed on the terminal TE.

During a step E2, the terminal TE opens a communication channel with the application server SERV of the communication network RES and subscribes to communication request notifications intended for it.

The terminal TE thus informs the application server SERV that the terminal TE is available to communicate.

For that, during the step E2, the terminal TE sends to the application server SERV an HTTP request comprising:
an indication relating to an IP address of the terminal TE, associated with an indication of an identity associated with the terminal TE,
an indication relating to the contacts with which the user of the terminal TE accepts communication, here the request comprises an identity associated with the user of the terminal TR,
an indication relating to the communication mode according to which the user of the terminal TE accepts communication, here the request includes a voice and text communication mode.

The terminal TE can send a distinct request for each communication mode according to which the user of the terminal TE accepts communication. For example, the terminal TE can send a first request indicating the voice communication mode and a second request indicating the text communication mode. The terminal TE can also send other requests relating to other communication modes according to which the user of the terminal TE accepts communication.

The terminal TE can also send other requests relating to other contacts with which the user of the terminal TE accepts communication.

Following the step E2, the terminal TE has subscribed to the notifications of voice and text mode communication requests sent subsequently by the terminal TR to the terminal TE.

During a step E1′, the user of the terminal TR starts up the communication service of his or her terminal by starting up an execution of the web browser installed on the terminal TR.

During a step E2′, the terminal TR opens a communication channel with the application server SERV of the communication network RES and subscribes to communication request notifications intended for it. The terminal TR thus informs the application server SERV that the terminal TR is available to communicate. For that, during the step E2′, the terminal TR sends to the application server SERV an HTTP request comprising:
an indication relating to an IP address of the terminal TR, associated with an indication of an identity associated with the terminal TR,
an indication relating to the contacts with which the user of the terminal TR accepts communication, here the request comprises an identity associated with the user of the terminal TE,
an indication relating to the communication mode according to which the user of the terminal TR accepts communication, here the request includes a voice and text communication mode.

Such an HTTP request can for example be a “subscribeObject” request.

The terminal TR can send a distinct request for each communication mode according to which the user of the terminal TR accepts communication. For example, the terminal TR can send a first request indicating the voice communication mode and a second request indicating the text communication mode. The terminal TR can also send other requests relating to other communication modes according to which the user of the terminal TR accepts communication.

The terminal TR can also send other requests relating to other contacts with which the user of the terminal TR accepts communication.

Following the step E2′, the terminal TR has subscribed to the notifications of voice and text mode communication requests sent subsequently by the terminal TE to the terminal TR.

During a step E3, the user of the terminal TE triggers, via the web browser executed by the terminal TE, a voice mode communication request to the user of the terminal TR, for example by clicking on a link associated with the user of the terminal TR. Such a link is for example included in a web page of a directory displayed by the web browser.

Following the step E3, during a step E4, the terminal TE sends to the application server SERV a request for communication with the terminal TR in the form of an HTTP “setObject” request comprising information allowing the terminal TR to set up a communication with the terminal TE. Such information includes:
an indication relating to the transmitter of the communication request: the user of the terminal TE,
an indication relating to the recipient of the communication request: the user of the terminal TR,
an indication relating to the requested communication mode: voice mode,
an indication relating to the state of the communication, here, the communication is in the “ringing” state.

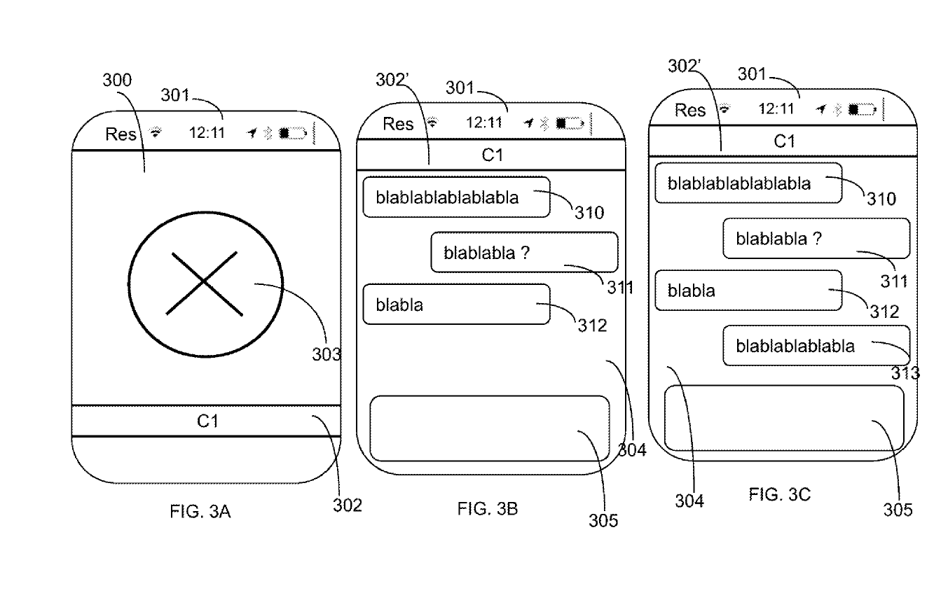

During the step E4, the terminal TE having sent a communication request to the terminal TR, the terminal TE modifies its display to display an interface informing the user of the terminal TE that a communication request is in progress. Such an interface is for example illustrated by FIG. 3A.

FIG. 3A illustrates a screen of the terminal TE when a communication request is currently being processed. FIG. 3A comprises an area 301 in which general information relating to the terminal TE is displayed, such as the name of the mobile network to which the terminal TE is connected (Res), the strength of the signal needed for the connection to such a network, the time, a symbol indicating whether the Bluetooth© technology of the terminal is activated, the level of charge of the battery of the terminal.

FIG. 3A comprises an area 300 representing an interface informing the user of the terminal TE that a voice mode communication request is in progress. The area 300 comprises an area 302 in which an indication (C1) relating to the recipient of the communication request in progress. Such an indication C1 corresponds for example to the name of the user of the terminal TR.

The area 300 also comprises a symbol 303 indicating that the voice mode communication request is in progress. Such a symbol can be activated by the user of the terminal TE if he or she wants, for example, to terminate the communication request destination for the terminal TR before the setting up of the communication. During a step E5, following the reception by the application server SERV of the communication request according to the voice communication mode sent by the terminal TE during the step E4, the application server SERV detects that the terminal TR was registered with it during the step E2′ and that the terminal TR accepts communication with the terminal TE according to the voice communication mode. During the step E5, the application server SERV sends to the terminal TR a communication request notification in the form of an HTTP “onObject” request comprising:
an indication relating to the transmitter of the communication request: the user of the terminal TE,
an indication relating to the recipient of the communication request: the user of the terminal TR,
an indication relating to the requested communication mode: voice mode,
an indication relating to the state of the communication, here, the communication is in the “ringing” state.

The terminal TR receives such a notification during the step E5. According to the WebRTC technology, such a notification corresponds to a communication request. During a step E6, the terminal TR then triggers a presentation of the communication request to the user of the terminal TR. Such a presentation of the communication request corresponds, for example, to the triggering of a ringing phase informing the user of the terminal TR of the reception of the communication request. During the step E6, the terminal TR also modifies its display in order to display a presentation interface for the communication request received during the step E5. The presentation interface for the communication request offers the user of the terminal TR at least one communication mode different from the communication mode requested in the communication request.

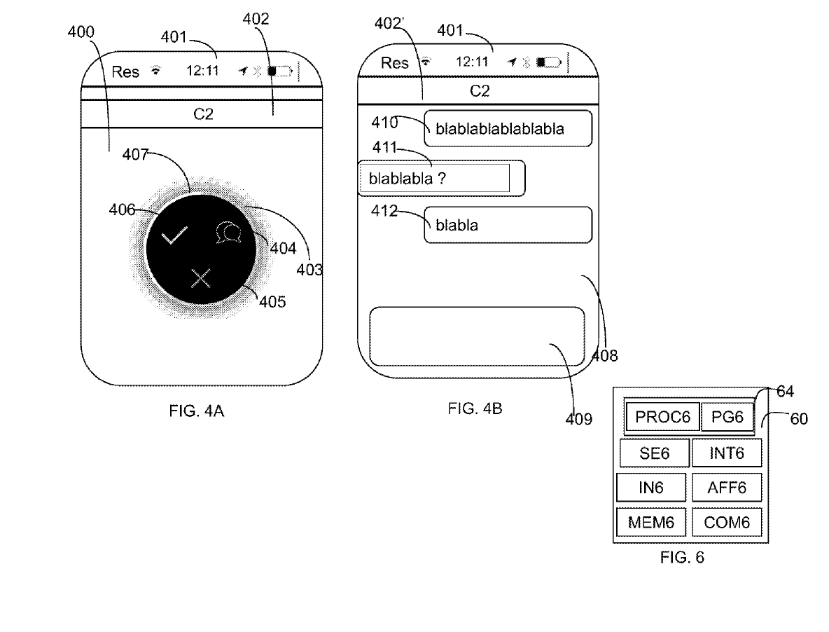

An example of a presentation interface for the communication request is illustrated by FIG. 4A according to a particular embodiment of the invention. FIG. 4A illustrates a screen of the terminal TR when a received communication request is presented to the user of the terminal TR. FIG. 4A comprises an area 401 in which general information relating to the terminal TR is displayed such as the name of the mobile network to which the terminal TR is connected (Res), the strength of the signal needed for the connection to such a network, the time, a symbol indicating whether the Bluetooth© technology of the terminal is activated, the level of charge of the battery of the terminal.

FIG. 4A comprises an area 400 representing an interface informing the user of the terminal TR of the reception of a voice mode communication request. The area 400 comprises an area 402 in which an indication (C2) relating to the transmitter of the communication request. Such an indication C2 corresponds for example to the name of the user of the terminal TE. The area 400 also comprises a symbol 403 showing three areas 404, 405 and 406 relating to three possible communication request response modes. Each area 404, 405 and 406 can be activated by the user of the terminal TR when he or she selects a response mode.

In the area 406, the response mode presented corresponds to the voice mode communication request acceptance mode. If the user selects this response mode, the communication will be set up between the terminal TE and the terminal TR according to the voice or audio communication mode.

In the area 405, the response mode presented corresponds to the communication request rejection mode. If the user selects this response mode, the communication request will be rejected by the terminal TR. In this case, the terminal TE will see its communication request fail and will possibly be redirected to a messaging server on which it will be able to post a message intended for the user of the terminal TR.

In the area 404, the response mode presented corresponds to the acceptance mode of the communication request according to another communication mode. Such another communication mode is different from the communication mode proposed in the communication request received.

For example, the other communication mode corresponds to a text communication mode. If the user selects the response mode presented in the area 404, the communication will be set up in text mode between the terminal TE and the terminal TR.

According to a particular embodiment of the invention, prior to the modification of the display of the terminal TR, during the step E6, the other communication mode is determined by the terminal TR based on an indication stored on the terminal TR and associated with the user of the terminal TE. For example, the terminal TR stores information relating to the communication habits or preferences between the terminal TR and the terminal TE, notably information relating to the communication mode used in communications set up previously between the terminal TR and the terminal TE. This particular embodiment makes it possible to adapt the other communication mode according to the transmitter of the communication request. For example, the other communication mode determined according to this particular embodiment of the invention is the text communication mode.

According to another particular embodiment of the invention, the area 400 can include other possible communication modes for setting up the requested communication that can be selected by the user (not represented). For example, the terminal TR can propose a drawing communication mode or a video communication mode.

According to another particular embodiment of the invention, the area 400 comprises visual information 407 indicating the time remaining before the terminal TR rejects the communication request. This visual information 407 makes it possible to indicate to the user of the terminal TR the time remaining to select a possible communication request response mode. Following the step E6 during which the terminal TR modifies its display to present the communication request received, the user of the terminal TR selects, during a step E7, the response mode presented in the area 404 of the interface 400 of FIG. 4A. The selection of such a response mode corresponds to the selection of another communication mode used to set up the requested communication. The user of the terminal TR has here selected the text communication mode.

During a step E8, the terminal TR then sends to the terminal TE a communication request acceptance message. The acceptance message is sent via the application server SERV in the form of an HTTP “setObject” request comprising an indication of the state of the communication request received in the step E5 indicating a state of switchover of the communication in voice or audio mode to a communication in text mode. Thus, the acceptance message sent by the terminal TR includes the other communication mode selected by the user of the terminal TR.

During a step E9, following the reception by the application server SERV of the request sent by the terminal TR during the step E8, the application server SERV transmits to the terminal TE the communication request acceptance message sent by the terminal TR in the form of an HTTP “onObject” request including an indication of the state of switchover of the communication in voice or audio mode to a communication in text mode. The terminal TE receives the communication request acceptance message during the step E9, such an acceptance message including the other communication mode selected by the user of the terminal TR.

During a step E10, the terminal TE then modifies its display so as to display a communication interface relating to the communication mode included in the acceptance message received in the step E9, here the text communication mode. Such a modification of the display is for example illustrated by FIG. 3B. FIG. 3B illustrates a screen of the terminal TE comprising an area 301 in which general information relating to the terminal TE is displayed, such as the name of the mobile network to which the terminal is connected (RES), the strength of the signal needed for the connection to such a network, the time, a symbol indicating whether the Bluetooth© technology of the terminal is activated, the level of charge of the battery of the terminal.

The screen also comprises a communication interface 304 comprising:
a group of messages (310-312) exchanged between the user of the terminal TE and the user of the terminal TR during communications set up previously. The messages displayed on the left side of the screen and represented with a darker background (310, 312) correspond to the messages received by the terminal TE from the terminal TR. The messages displayed on the right side of the screen and represented with a lighter background (311) correspond to the messages sent by the terminal TE to the terminal TR.
an area 302′ in which is displayed information C1 associated with the user of the terminal with which the messages displayed have been exchanged, here the user of the terminal TR. Such information C1 corresponds for example to the name of the user of the terminal TR.
a message composition area 305 in which the user of the terminal TE can compose a text message intended for the user of the terminal TR.

During a step E11, the terminal TR modifies its display so as to display a communication interface relating to the other communication mode selected. Such a modification of the display is for example illustrated by FIG. 4B.

FIG. 4B illustrates a screen of the terminal TR comprising an area 401 in which general information relating to the terminal TR is displayed such as the name of the mobile network to which the terminal is connected (RES), the strength of the signal needed for the connection to such a network, the time, a symbol indicating whether the Bluetooth© technology of the terminal is activated, the level of charge of the battery of the terminal.

The screen also comprises a communication interface 408 comprising:
a group of messages (410-412) exchanged between the user of the terminal TE and the user of the terminal TR during communications set up previously. The messages displayed on the right side of the screen and represented with a lighter background (410, 412) correspond to the messages received by the terminal TR from the terminal TE. The messages displayed on the left side of the screen and represented with a darker background (411) correspond to the messages sent by the terminal TR to the terminal TE.
an area 402′ in which is displayed information C2 associated with the user of the terminal with which the messages displayed have been exchanged, here the user of the terminal TE. Such information C2 corresponds for example to the name of the user of the terminal TE.
A message composition area 409 in which the user of the terminal TR can compose a text message intended for the user of the terminal TE.

During a step E12, the user of the terminal TR composes a message in the composition area 409 intended for the user of the terminal TE. When the message is validated by the user of the terminal TR via a validation key of the interface 408 (not represented), the message is sent to the terminal TE during the step E12. The sending of the message composed during the step E12 by the terminal TR is equivalent to the sending of a communication request according to the text communication mode, sent by the terminal TR to the terminal TE. The sending of such a text communication request makes it possible to set up a communication between the terminal TE and the terminal TR according to the text communication mode.

The composed message is sent, via the application server SERV, in the form of an HTTP “setObject” request comprising information allowing the terminal TE to set up a communication with the terminal TR. Such information includes:
an indication relating to the transmitter of the communication request: the user of the terminal TR,
an indication relating to the recipient of the communication request: the user of the terminal TE,
an indication relating to the communication mode requested: text mode,
the composed message.

During the step E12, the application server SERV receives the request sent by the terminal TR. During a step E13, the application server SERV transmits to the terminal TE the message composed on the terminal TR in the form of an HTTP “onObject” request comprising:
an indication relating to the transmitter of the communication request: the user of the terminal TR,
an indication relating to the recipient of the communication request: the user of the terminal TE,
an indication relating to the communication mode requested: text mode,
the composed message.

The terminal TE receives the request sent by the application server SERV during the step E13. The reception of such a request makes it possible to set up a text message communication session between the terminal TE and the terminal TR. The terminals TE and TR can then communicate during a step E14, via exchanges of text messages without involving the application server SERV.

The message received by the terminal TE during the step E13 is then displayed by the terminal TE in the interface 304 comprising the messages exchanged with the terminal TR already displayed by the terminal TE.

FIG. 3C illustrates, for example, such a message 313. According to a particular embodiment of the invention, the characters of the message composed by the user of the terminal TR during the step E11 are sent to the terminal TE as soon as they are entered into the message composition area 409. The first character of the message is sent in the form of an HTTP “setObject” request as described previously.

The subsequent characters of the message are sent according to the data transport protocol used during the communication session in text mode.

Upon the reception by the terminal TE of a character of the message composed by the user of the terminal TR, the terminal TE displays each character received as soon as it is received. The user of the terminal TE can then read the message during composition without having to wait for the message to be validated by the user of the terminal TR.

According to the invention, the modification of the display of the terminal TE during the step E10 and the reception of the composed message during the step E13 make it possible to inform the user of the terminal TE of the acceptance by the terminal TR of the communication request initiated in the step E4 by the terminal TE, according to another communication mode different from the communication mode initially requested. The user of the terminal TE does not need to interact on his or her terminal TE to know the response to the communication request from the terminal TR or to modify the communication mode.

Furthermore, the modification of the display of the terminal TR during the step E11 following the acceptance of the communication request received during the step E5 according to another communication mode, makes it possible to avoid requiring the user of the terminal TR to interact on his or her terminal TR to modify the communication application that he or she wants to use to communicate with the terminal TE. The sending of the message composed in the step E12 makes it possible to set up a communication session according to the other communication mode desired by the user of the terminal TR without the latter having to interact on his or her terminal.

In a variant, the setting up of the communication session according to the other communication mode can be done at the initiative of the terminal TE if the user of the terminal TE composes a message in the composition area 305 before the reception of a message composed by the user of the terminal TR. The setting up of such a communication session is then done by the sending of an HTTP “setObject” request similar to that described in relation to the step E12 but sent by the terminal TE.

The mechanism which has just been described applies also to the cases where the other communication mode is a real-time drawing mode communication mode.

In a variant, the other communication mode can be an audio or video communication mode. For example, during the step E4, the initial communication request can be a request for communication according to the text mode. During the step E7, the user of the terminal TR can choose an audio communication mode as other communication mode. During the step E10, respectively E11, the terminal TE, respectively TR, modifies its display so as to display an interface relating to the communication application used to communicate according to the audio communication mode. In this case, the communication session according to the audio communication mode is then set up via the sending by the terminal TR during the step E12 of an audio communication request in the form of an HTTP “setObject” request indicating the audio communication mode. The sending of such a communication request is done automatically by the terminal TR, following the modification of the display of the terminal TR. After the selection of the other communication mode by the user of the terminal TR (here the audio communication mode), the user of the terminal TR does not need to perform other additional interactions on his or her terminal TR to set up the communication session according to the other communication mode.

Generally, the communication request method and the communication method which have just been described can also be implemented according to any type of communication protocol.

According to another particular embodiment of the invention, the communication request method and the communication method can be implemented according to the SIP protocol. According to this other particular embodiment of the invention, the steps E2 and E2′ are performed by the sending of an SIP REGISTER message to the core communication network RES. During the step E4, the communication request is sent in the form of an SIP INVITE message.

During the step E8, the acceptance message for the communication request according to the other communication mode is sent in the form of an SIP 380 ALTERNATE SERVICE message comprising, in the body of such a message, an indication relating to the other communication mode selected during the step E7. The reception of such a message by the terminal TE during the step E9 then triggers the modification of the display of the terminal TE to display a communication interface relating to the other communication mode. The sending of such a message by the terminal TR during the step E8 triggers the modification of the display of the terminal TR to display a communication interface relating to the other communication mode.

The communication session according to the other communication mode selected during the step E7 is set up by the sending by the terminal TR of an SIP INVITE message during the step E12. When the other communication mode selected during the step E7 is a text or drawing communication mode, the sending of such a message is for example performed following the composition of a text message or of a drawing by the user of the terminal TR.

When the other communication mode selected during the step E7 is an audio or video communication mode, the sending of such a message is performed following the modification of the display of the terminal TR during the step E11.

According to this other particular embodiment of the invention, in response to the SIP INVITE message received by the terminal TE during the step E13, from the terminal TR, the terminal TE accepts the communication request by the sending of an SIP 2000K message to the terminal TR. Such a message is acknowledged by the terminal TR by the sending to the terminal TE of an SIP ACK message. The communication session according to the other communication mode is thus set up between the terminal TE and the terminal TR. During the step E14, the terminal TE and the terminal TR then communicate for example by exchanging data according to the RTP protocol.

FIG. 5 illustrates a device capable of implementing the communication request method according to a particular embodiment of the invention.

The device 50 is capable of implementing the communication request method between a terminal transmitting said communication request and a receiving terminal according to a particular embodiment of the invention described in relation to FIG. 2.

The device 50 comprises a processing module 54, notably comprising a storage module MEM, for example a memory, and a processing unit PROC, equipped for example with a microprocessor. The processing unit PROC is driven by a computer program PG implementing the communication request method between a terminal transmitting said communication request and a receiving terminal as described in relation to FIG. 2.

On initialization, the code instructions of the computer program PG are for example loaded into memory MEM before being executed by the processor of the processing unit PROC.

The processor of the processing unit PROC implements the steps of the communication request method between a terminal transmitting said communication request and a receiving terminal, according to the instructions of the computer program PG. The processor of the processing unit PROC notably implements:
a step of reception by the transmitting terminal of a communication request acceptance message, the acceptance message including another communication mode different from the proposed communication mode,
following the step of reception of the acceptance message, a step of modification of the display of a display device associated with the transmitting terminal so that a communication interface relating to said other communication mode is displayed,
a step of communication between the receiving terminal and the transmitting terminal according to said other communication mode, via said communication interface.

The device 50 also comprises a display device AFF, such as a screen incorporated in the device 50 or connected to the device 50.

The display on the display device AFF is controlled by a display interface INT. The display interface INT is itself controlled by the processor of the processing unit PROC according to the code instructions of the computer program PG and of the operating system SE of the device 50.

The device 50 also comprises a communication module COM enabling the device 50 to connect to a communication network and to exchange data with terminals connected to this communication network, or to set up communications with other terminals. The communication module COM is capable of sending a communication request to the receiving terminal and of receiving an acceptance message from the receiving terminal.

On reception by the communication module COM of the acceptance message including the other communication mode, the processing module 54 controls the display interface INT according to the code instructions of the computer program PG in order to modify the display on the display device AFF.

According to a particular embodiment of the invention, the device 50 is included in a terminal, such as a mobile or fixed terminal, or a tablet.

FIG. 6 illustrates a device capable of implementing the communication method according to a particular embodiment of the invention.

The device 60 is capable of implementing the communication method between a terminal transmitting a communication request and a receiving terminal according to a particular embodiment of the invention described in relation to FIG. 2.

The device 60 comprises a processing module 64, notably comprising a storage module MEM6, for example a memory, and a processing unit PROC6, equipped for example with a microprocessor. The processing unit PROC6 is driven by a computer program PG6 implementing the communication method between a terminal transmitting a communication request and a receiving terminal as described in relation to FIG. 2.

On initialization, the code instructions of the computer program PG6 are for example loaded into memory MEM6 before being executed by the processor of the processing unit PROC6.

The processor of the processing unit PROC6 implements the steps of the communication method between a terminal transmitting a communication request and a receiving terminal, according to the instructions of the computer program PG6. The processor of the processing unit PROC6 notably implements:
a step of reception by the receiving terminal of the communication request, the communication request including a communication mode proposed to set up the requested communication,
following a user interaction performed on the receiving terminal indicating the selection of another communication mode different from the proposed communication mode, a step of sending to the transmitting terminal of an acceptance message, the acceptance message including said other selected communication mode,
following the step of sending of the acceptance message, a step of modification of the display of a display device associated with the receiving terminal so that a communication interface relating to said other communication mode is displayed,
a step of communication between the receiving terminal and the transmitting terminal according to said other communication mode, via said communication interface.

The device 60 also comprises a display device AFF6, such as a screen incorporated in the device 60 or connected to the device 60.

The display on the display device AFF6 is controlled by a display interface INT6. The display interface INT6 is itself controlled by the processor of the processing unit PROC6 according to the code instructions of the computer program PG6 and of the operating system SE6 of the device 60.

The device 60 comprises a user interaction module IN6 allowing a user to interact on the device 60. The user interaction module IN6 notably allows a user to indicate the selection of another communication mode different from the proposed communication mode, upon the reception of the communication request from the transmitting terminal.

According to a particular embodiment of the invention, the user interaction module IN6 is a touch interface. According to another particular embodiment of the invention, the user interaction module IN6 is a touch interface incorporated in the screen associated with the device. The screen associated with the device is then a touch screen.

The device 60 also comprises a communication module COM6 allowing the device 60 to connect to a communication network and to exchange data with terminals connected to this communication network, or to set up communications with other terminals. The communication module COM6 is capable of receiving a communication request from the transmitting terminal and of sending an acceptance message including the other communication mode to the transmitting terminal. On detection by the user interaction module IN6 of a user interaction indicating the selection of another communication mode different from the communication mode proposed in the communication request received, the user interaction module IN6 communicates with the processing module 64 in order to indicate the detection of the user interaction. The processing module 64 then controls the display interface INT6 according to the code instructions of the computer program PG6 in order to modify the display on the display device AFF6. The display device AFF6 then displays a communication interface relating to the other communication mode.

According to a particular embodiment of the invention, the storage module MEM6 makes it possible to store information relating to the user of the transmitting terminal or an indication relating to the habitual modes of communication between the transmitting terminal and the receiving terminal. The processing module 64 is capable of determining another communication mode according to such information stored by the storage module MEM6.

According to another particular embodiment of the invention, the display interface INT is capable, on command from the processing module 64, of controlling the display by the display device AFF of an interface comprising visual information indicating the time remaining before a rejection of the communication request by the receiving terminal. According to this other particular embodiment of the invention, when the display interface INT controls the display on the display device AFF of a response mode selection interface following the reception of the communication request by the communication module COM, a seconds counter is set to zero. The counter is increased by 1 each second until the value of the counter has reached a predetermined threshold. The predetermined threshold corresponds to the time, expressed in seconds for example, before the receiving terminal rejects the communication request received. When the counter reaches the predetermined threshold, if the user of the receiving terminal has not selected any response mode to the communication request, the communication request is rejected by the receiving terminal. The processing module 64 controls the display interface INT to display periodically, for example every second, information representative of the counter value. Such representative information is for example illustrated by the element 407 of FIG. 4A. The element 407 represents a ring inside which the grey area represents the time elapsed since the start of the presentation of the communication request and the white area represents the time remaining before the communication request is rejected. On each modification of the display by the display interface INT, the user of the receiving terminal can see the trend of the counter. According to this particular embodiment of the invention, the user of the receiving terminal is informed of the time remaining before the communication request is rejected by the receiving terminal.

According to one particular embodiment of the invention, the device 60 is included in a terminal, such as a mobile or fixed terminal, or a tablet.

1. A communication method between a terminal transmitting a communication request and a receiving terminal, the method comprising:
receiving, by the receiving terminal, of the communication request, the communication request including a communication mode proposed for setting up the requested communication,
following the detection of a user interaction indicating the selection of another communication mode, the other communication mode being different from the proposed communication mode and not included in the proposed communication mode, sending an acceptance message to the transmitting terminal, the acceptance message including said other selected communication mode,
following the sending of the acceptance message, modifying the display of a display device associated with the receiving terminal so that a communication interface relating to said other communication mode is displayed, and
communicating between the receiving terminal and the transmitting terminal according to said other communication mode, via said communication interface.

2. The method of claim 1, wherein the proposed communication mode is an audio or video communication mode.

3. The method of claim 1, wherein the other communication mode is a real-time text or drawing communication mode.

4. The communication method of claim 1, further comprising determining the other communication mode, based on an indication associated with a user of the terminal transmitting the communication request, the indication being stored on the receiving terminal.

5. The method of claim 1, further comprising:
obtaining a parameter representative of the time remaining before a rejection of the communication request by the receiving terminal; and
modifying the display of the display device so as to display the parameter obtained.

6. The method of claim 3, wherein the other communication mode is a text communication mode and, when a message is composed via the communication interface displayed on the display device associated with the receiving terminal, the composed message is sent character-by-character to the transmitting terminal.

7. A method for requesting a communication between a terminal transmitting said communication request and a receiving terminal, the communication request including a communication mode proposed for setting up the requested communication, the method comprising:
receiving, by the transmitting terminal, of a communication request acceptance message, the acceptance message including another communication mode different from the proposed communication mode,
following the reception of the acceptance message, modifying the display of a display device associated with the transmitting terminal so that a communication interface relating to said other communication mode is displayed, and
communicating between the receiving terminal and the transmitting terminal according to said other communication mode, via the communication interface.

8. A communication terminal comprising a communication module and a processing module:
the communication module capable of:
receiving a communication request from a transmitting terminal, the communication request including a communication mode proposed for setting up the requested communication,
sending, on command from the processing module, to the transmitting terminal, an acceptance message including another communication mode different from the proposed communication mode, and
communicating with the transmitting terminal according to said other communication mode, via a communication interface relating to said other communication mode,
the processing module capable of:
controlling the communication module following a user interaction performed on the communication terminal indicating the selection of said other communication mode,
controlling a display interface to modify the display of a display device associated with the communication terminal so that said communication interface relating to said other communication mode is displayed.

9. A terminal (50) requesting a communication comprising:
a communication module (COM) capable of:
sending, to a receiving terminal, a communication request including a communication mode proposed for setting up the requested communication,
receiving a communication request acceptance message, the acceptance message including another communication mode different from the proposed communication mode, and
communicating with the receiving terminal according to said other communication mode, via a communication interface relating to said other communication mode, and
a processing module capable of controlling a display interface following the reception of the acceptance message, to modify the display of a display device associated with the terminal so that the communication interface relating to said other communication mode is displayed.

10. A non-transitory computer-readable medium having stored thereon instructions, which when executed by a processor, cause the processor to perform a communication method between a terminal transmitting a communication request and a receiving terminal, the method comprising:
receiving, by the receiving terminal, of the communication request, the communication request including a communication mode proposed for setting up the requested communication,
following the detection of a user interaction indicating the selection of another communication mode, the other communication mode being different from the proposed communication mode and not included in the proposed communication mode, sending to the transmitting terminal of an acceptance message, the acceptance message including said other selected communication mode,
following the sending of the acceptance message, modifying the display of a display device associated with the receiving terminal so that a communication interface relating to said other communication mode is displayed, and
communicating between the receiving terminal and the transmitting terminal according to said other communication mode, via said communication interface.

11. A non-transitory computer-readable medium having stored thereon instructions, which when executed by a processor, cause the processor to perform a method for requesting a communication between a terminal transmitting said communication request and a receiving terminal, the communication request including a communication mode proposed for setting up the requested communication, the method comprising:
receiving, by the transmitting terminal, of a communication request acceptance message, the acceptance message including another communication mode different from the proposed communication mode,
following the reception of the acceptance message, modifying the display of a display device associated with the transmitting terminal so that a communication interface relating to said other communication mode is displayed, and
communicating between the receiving terminal and the transmitting terminal according to said other communication mode, via the communication interface.

12. The method of claim 4, wherein the other communication mode is a text communication mode and, when a message is composed via the communication interface displayed on the display device associated with the receiving terminal, the composed message is sent character-by-character to the transmitting terminal.
